(19) United States
(12) Patent Application Publication
(10) Pub. No.: US 2015/0219064 A1
(43) Pub. Date: Aug. 6, 2015

(54) Blade Wheel of a Kaplan Turbine

(71) Applicant: Voith Patent GmbH, Heidenheim (DE)

(72) Inventors: Gregory Snyder, York, PA (US); Franklin Stinson, York, PA (US); Thomas Neidhardt, Heidenheim (DE)

(73) Assignee: Voith Patent GmbH, Heidenheim (DE)

(21) Appl. No.: 14/425,895

(22) PCT Filed: Aug. 1, 2013
(86) PCT No.: PCT/EP2013/066142

§ 371 Date: Mar. 4, 2015

(30) Foreign Application Priority Data
Nov. 20, 2012 (DE) 10 2012 022 583.0

(51) Int. Cl. F03B 3/06; F03B 11/00; F03B 3/12

(52) U.S. Cl. CPC F03B 3/06; F03B 3/123; F03B 11/002

(57) ABSTRACT

The invention relates to an impeller for a Kaplan turbine, comprising the following features or components: a shaft, a plurality of blades; a hollow hub which is located on the free end of the shaft and which carries the blades; an adjustment device for rotating the blades around axes of rotation perpendicular to the axis of rotation of the shaft. The invention is characterized by the following features: the interior of the hub is connected to a source of compressed air; branch lines are provided inside the hub to supply the compressed air to bearings or other lubrication points for the adjustment device.

The invention relates to Kaplan turbines (see DE 101 00 963 A1 for example).

Such a Kaplan turbine comprises a blade wheel, a guide wheel and a housing as its relevant parts. The blade wheel is provided with adjustable blades and is coupled to the shaft.

There are Kaplan turbines with a vertical shaft, but also such with a horizontal shaft.

An especially interesting application of Kaplan turbines with a horizontal shaft has become known. In this case, a retaining barrage or a wicket of a weir, e.g. in a river power station, is equipped with a large number of Kaplan turbines, e.g. with 6, 12, 24 or more turbines. The individual Kaplan turbine is obviously very small in this case. It can be removed easily and rapidly in the case of damage and can be exchanged for a new turbine. It is intended to keep the configuration of the turbine as simple as possible (see U.S. Pat. No. 5,825,094 for example).

The aforementioned adjusting devices are relatively complex with respect to their design. Their smooth function is exceptionally important for the functionality of the entire turbine. The moved parts need to be lubricated. It is known to use oil or water for this purpose. The interior space of the hub is filled with water or oil for this purpose. If water is used, there is a likelihood of corrosion. If oil is used, there is a likelihood of environmental pollution when the hub shows leakages.

The invention is based on the object of providing a Kaplan turbine in such a way that neither corrosion nor environmental pollution occurs. This object is achieved by the features of claim 1.

Accordingly, the hub is provided with a connection for introducing compressed air into the hollow interior space. The interior space is thus under pressure above atmospheric during the operation of the turbine. All moved parts can thus be supplied with compressed air. The compressed air replaces lubrication by oil or by water. Self-lubricating sealing and bearing materials are appropriately used instead of oil-lubricated or water-lubricated bearings and seals.

The invention is especially suitable for retrofitting existing turbines to water-free or oil-free operation.

The invention further offers the following advantage: compressed air can be supplied from the hub through the blades of an anti-cavitation rib. The likelihood of cavitation can thus be reduced. It is also prevented that water will penetrate the interior space.

Conventional turbines with oil-lubricating bearings can easily be retrofitted within the terms of the invention. The existing lines for supplying lubricating oil to the bearings can be used as air conduits.

The prior art and the invention are explained in closer detail by reference to the drawings, which show the following in detail:

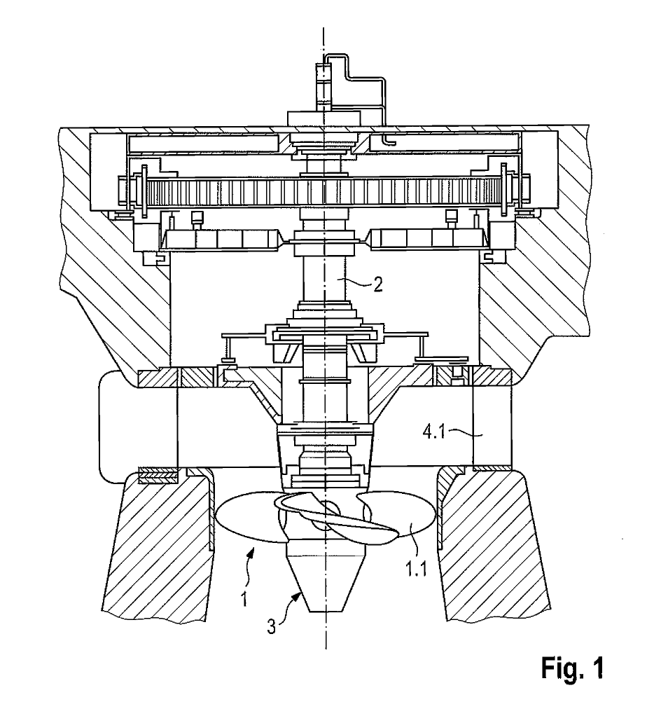

FIG. 1 shows a Kaplan turbine according to the state of the art in an upright projection and partly in a sectional view, comprising adjustable blades;

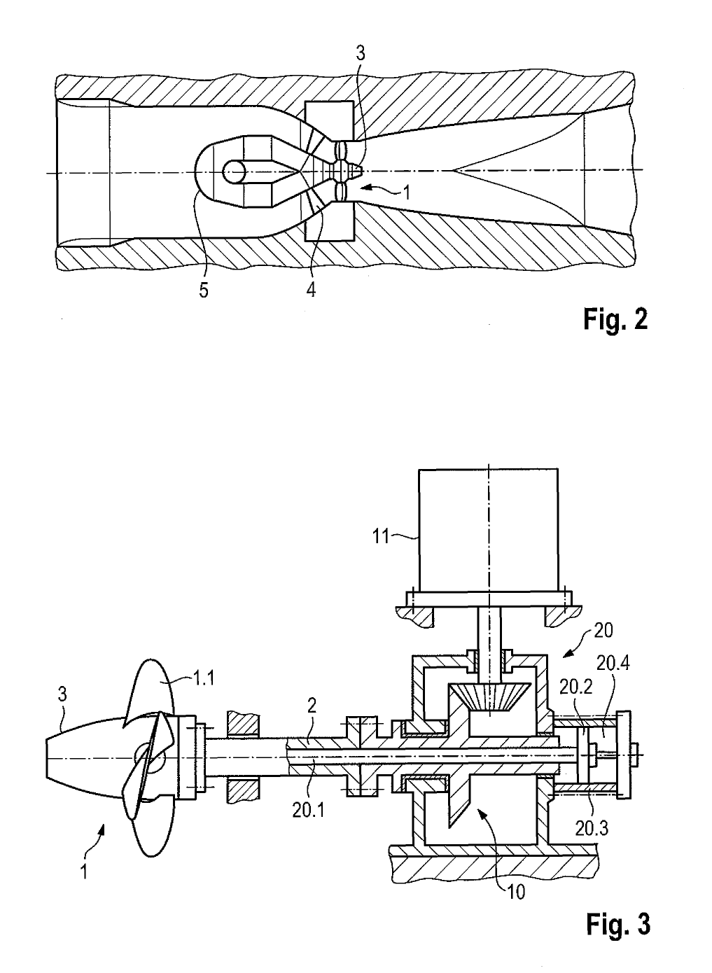

FIG. 2 shows a tube turbine according to the state of the art in an axial sectional view;

FIG. 3 shows a Kaplan blade wheel according to the state of the art in a shaft and an inner blade adjusting unit;

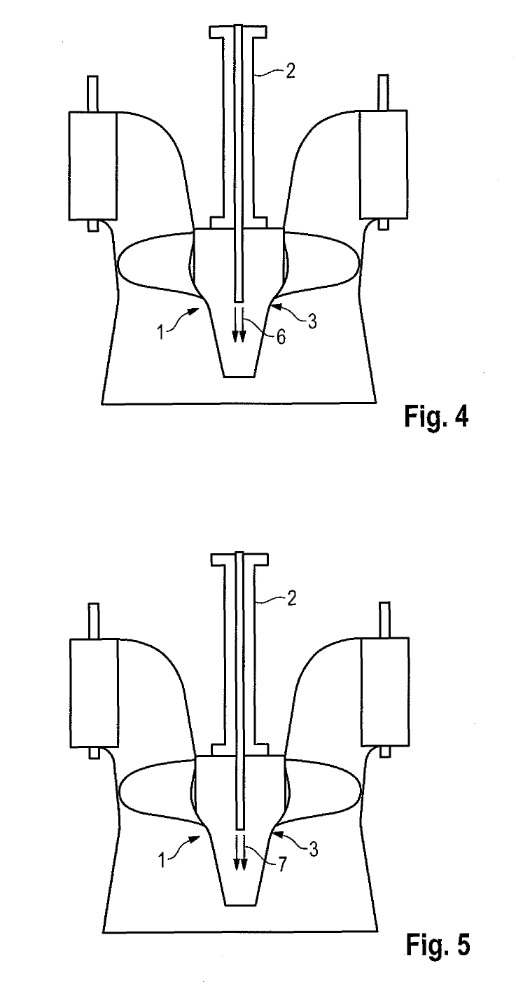

FIG. 4 shows a schematic view of a Kaplan turbine according to the state of the art with an oil-filled or water-filled hub;

FIG. 5 shows a Kaplan turbine in a view similar to that according to FIG. 4, but with a hub filled with compressed air.

The Kaplan turbine shown in FIG. 1 comprises a blade wheel 1 which is carried by a shaft 2. The shaft 2 is arranged vertically. The turbine mechanism comprises adjustable blade wheels 1.1.

The shaft comprises a hub 3 at its free end. A guide blade ring 4 is further provided. It is mounted in the hub 3. The guide blades 4.1 are also adjustable.

An adjusting unit in accordance with the invention is used for adjustment, in which an adjusting force is applied which is proportional to the head.

The Kaplan turbine shown in FIG. 2 is a tube turbine with a horizontal shaft. A hub 3 is also shown here. The turbine again comprises the same components as the turbine of FIG. 1. The illustration shows a blade wheel 1 and further a guide blade ring 4.

A housing 5 is provided which surrounds a generator. The generator sits on the shaft of the blade wheel 1.

An adjusting unit similar to the one of FIG. 1 is also provided in this case. The adjusting unit is situated in the housing 5 and extends up to the hub 3.

FIG. 3 shows an adjusting unit which can be used in the embodiments of FIGS. 1 and 2. The illustration also shows a blade wheel 1 with blades 1.1. The blade wheel 1 is carried by a hub 3. A bevel gear 10 transmits torque to a generator 11, which torque is produced on the blade wheel 1.

The adjusting unit 20 comprises a pushrod 20.1. The downstream end of the pushrod 20.1 is not shown here. It is guided through a hollow shaft 2 up to the blade wheel. It acts there on the adjustable blades 1.1 in such a way that a displacement of the pushrod 20.1 in the axial direction produces an adjustment of the blades 1.1.

The upstream end of the pushrod 20.1 carries a plate 20.2. It is arranged in a cylinder 20.3 and is axially displaceable therein in the manner of a piston. The swept volume 20.4 to the right of the plates 20.2 can be subjected to a pressure which is equal or proportional to the head. If the head rises, the pressure also rises in the swept volume 20.4. The pushrod 20.1 is thus displaced toward the blade wheel 1, as a result of which the blade wheels 1.1 are pivoted or adjusted within the terms of closing.

If the head decreases, the pushrod travels in the opposite direction again with the tendency of opening the blade wheels 1.1. This return movement can be initiated in different ways, e.g. by a restoring spring (not shown). A gas pressure can also prevail in the part of the cylinder space which is situated on the side of plate 20.2 which is opposite of the swept volume 20.4.

The known embodiment shown in FIG. 3 could also be referred to as an inner adjusting gear.

The known Kaplan turbine shown in FIG. 4 comprises a blade wheel 1, a shaft 2 and a hub 3 carrying the blade wheel. The shaft is hollow. Oil is supplied to the hub 3 during operation (see the oil outlet).

The invention is realised in the Kaplan turbine according to FIG. 5. Compressed air is supplied in this case to the interior space of the hub 3 (see the compressed-air outlet 7).

### LIST OF REFERENCE NUMERALS

1 Blade wheel
1.1 Blades
2 Shaft
3 Hub
4 Guide blade ring
4.1 Guide blades
5 Housing
6 Oil outlet
7 Compressed-air outlet
10 Bevel gear
11 Generator
20 Adjusting unit
20.1 Pushrod
20.2 Plate
20.3 Cylinder
20.4 Swept volume

1-3. (canceled)

4. A blade wheel of a Kaplan turbine, the blade wheel comprising:
a shaft;
a plurality of blades;
a hollow hub situated at a free end of the shaft and carrying the plurality of blades;
an adjusting device for twisting the plurality of blades about rotational axes perpendicularly to a rotational axis of the shaft;
wherein bearings and other points to be lubricated are free of lubricating oil;
wherein an interior space of the hollow hub is connected to a compressed-air source;
wherein branch lines for supplying compressed air from the compressed-air source to the bearings or the other points of the adjusting device are provided in the interior space of the hollow hub;
wherein the interior space of the hollow hub is under a pressure above atmospheric pressure.

5. The blade wheel according to claim 4, wherein the adjusting device comprises a piston-cylinder actuator connected to the compressed-air source.

6. The blade wheel according to claim 4, wherein the adjusting device comprises a rod assembly displaceable parallel to the rotational axis of the shaft and a pinion gear for converting a displacing movement into a rotational movement of the blade wheel.
